(19) United States
(12) Patent Application Publication
(10) Pub. No.: US 2017/0028400 A1
(43) Pub. Date: Feb. 2, 2017

(54) RESERVOIR ASSEMBLY AND METHOD OF USE

(71) Applicant: Click Bio, Inc., Reno, NV (US)

(72) Inventors: Mykle Gaynor, Sparks, NV (US); Craig Vincze, Reno, NV (US)

(73) Assignee: Click Bio, Inc., Reno, NV (US)

(21) Appl. No.: 15/188,697

(22) Filed: Jun. 21, 2016

Related U.S. Application Data
(60) Provisional application No. 62/197,790, filed on Jul. 28, 2015.
(60) Provisional application No. 62/305,911, filed on Mar. 9, 2016.

(51) Int. Cl. B01L 3/00; B65D 21/02

(52) U.S. Cl. CPC B01L 3/52; B65D 21/0206; B01L 3/527; B01L 2300/0809; B01L 2200/025; B01L 2300/12; B01L 2200/16

(57) ABSTRACT

A reservoir assembly having one or more troughs mounted within a reservoir frame by interconnecting the one or more troughs to a reservoir frame, which is SBS-compliant in some embodiments. In some embodiments, each of the one or more troughs provides both mounting projections and projection mounting channels, and the reservoir frame provides a plurality of projection mounting channels or mounting projections. In embodiments having multiple such troughs, the troughs can be interconnected, and mounted to the reservoir frame, via mounting projections penetrating mating mounting channels. The reservoir assembly can include one or more troughs or other components having a wide variety of shapes and sizes. One or more components in the reservoir assembly may be opaque, and troughs may be stored and moved in an interconnected fashion, stabilizing the troughs and reducing spilling or splashing of contents.

### CROSS-REFERENCE TO RELATED APPLICATIONS

This application claims priority to, and incorporates by reference: (i) the applicants' prior provisional patent application, entitled Flexible Labware System, Ser. No. 62/197,790, filed Jul. 28, 2015; and (ii) the applicant's prior provisional patent application, entitled Adjustable Trough and Method of Use, Ser. No. 62/305,911, filed Mar. 9, 2016.

### COPYRIGHT NOTICE

This patent disclosure contains material subject to copyright protection. The copyright owner has no objection to the photocopy reproduction of the patent document or the patent disclosure in exactly the form it appears in the Patent and Trademark Office patent file or records, but otherwise reserves all copyright rights.

### FIELD OF THE DISCLOSURE

The present disclosure relates to one or more reagent troughs and methods of use, and in one aspect to SBS reagent troughs and their methods of use with robotics.

### BACKGROUND OF SOME ASPECTS OF THE DISCLOSURE

Reagent reservoirs have long been used to store and procure chemical reagents in laboratories. For example, one common use of a reagent reservoir stores the reagent for later use of a pipette to withdraw a desired amount of reagent from the reservoir and then utilize the pipette-contained reagent in some fashion in the lab.

Such reservoirs are typically made of plastic or similar substances. The reservoirs typically are fixed monolithic units that the user cannot alter. Many such reservoirs have fixed interior walls or baffles, some for the purpose of separating different liquids or powders from each other and some for the purpose of minimizing powder movement or liquid splashing when moving the reservoir.

Because of the different requirements of differing lab processes and apparatus, reservoirs have long been provided in a wide variety of differing, but fixed, sizes and configurations. For example, manual educational lab processes commonly utilize single-trough reagent reservoirs. Larger, more sophisticated labs, particularly industrial labs, have long utilized reagent reservoirs with multiple troughs provided by interior rows and columns, many also providing higher volumes for differing types of reagents. Consequently, a typical lab most often procure, and provide storage space for, a large number of reservoirs of differing configurations.

In addition, labs are often forced to choose between many different fixed styles of reservoirs, or use of multiple separate reservoirs. Using multiple separate reservoirs consumes more space in the work environment and on expensive laboratory automation equipment.

Many reagent reservoirs provide one or more troughs having bottom surfaces providing a number of chambers. Many reagent reservoirs are relatively narrow in dimension (e.g., width) as compared to another dimension (e.g., width). They can therefore can tip over easily, spilling their contents. This can also take place with other reservoir shapes as they are moved around, such as with respect to each other in a reservoir utilization process.

In the recent years, automated fluid utilization systems have become a popular in the chemical, pharmaceutical, biotech, and agrochemical industries. For example, specially-designed robotic systems are being used to (i) aspirate and dispense liquid samples from and to liquid reservoirs, (ii) transport samples between instruments, and (iii) store liquid samples during data screening processes.

In order to expand compatibility of components utilized in such systems from differing suppliers, the Society for Biomolecular Science (“SBS”) has established various standards for such systems, including dimensional standards for reagent reservoirs used in them. Such SBS-compliant automated systems therefore can be programmed to identify the precise location of a particular location within the container's frame, based on the dimension of the standardized “footprint” of the reservoir. Because of the need for positive placement of a component at a precise location in the reservoir footprint, the automated system often cannot utilize reservoirs not in compliance with SBS standards.

The automated SBS-compliant systems also typically utilize fixed, unitary reagent reservoirs containing multiple small troughs. Again, there are many different types of such unitary reagent troughs available, all of which typically have a fixed orientation and style of one or more reservoirs to accommodate a specific sets of requirements based on the type of liquid sample, experiment, or analysis process. Such reservoirs also typically are structured to be compatible with either individual pipette heads or multichannel pipette heads, but not both.

For example, pipette tip spacing (tip to tip) on multichannel pipette heads is 9 mm for a 96 channel head (8 rows by 12 columns). Beckman trough deep V bottoms do not comply with 9 mm spacing and are therefore only compatible with individual pipette heads.

One approach to making a given reservoir more flexible has been to provide modular, relatively tall troughs mountable in a bulky, similarly tall external frame extending vertically from the underlying support surface to approximately the upper edges of the troughs. The troughs mountable in such bulkly frames are only provided in tall full, half, and quarter sizes. The half and quarter sizes can only be mounted in one orientation in the surrounding frame, with opposed ends mounted to opposed sides of the frame. This prior art approach has thus also significantly limited user options for including differing types and shapes of troughs in the reservoir.

In addition, if the frame of this approach is not completely filled with components, the location of the components mounted in the frame can shift position easily during lab processing. Positive, non-shifting placement of labware can be critical, however, on automated systems because they can be programmed to perform tasks based on precise locations of the items to be used or manipulated by the robot/automated system.

Reagent reservoirs also typically are made of translucent material, and some may be tinted a particular color in order to contain light sensitive solutions. Because light may alter a reagent in undesirable ways, however, many laboratories wrap aluminum foil around reagent reservoirs to block light when desired.

### BRIEF SUMMARY OF SOME ASPECTS OF THE DISCLOSURE

The applicants have discovered that the fixed and un-adjustable reagent reservoirs provide too few options to users in the field. For example, when the experiment or process involves simultaneously manipulating multiple types of liquid samples that may require different storage conditions, fixed structures—commonly monolithic blocks with fixed perimeter and interior dimensions—can require the user to have to procure, and often store, many differing types of reservoirs.

One aspect of the present disclosure provides modular reagent troughs that can provide flexibility in modifying the orientation or location of one or more troughs in a reservoir assembly. In another aspect, the modular reagent troughs can have differing shapes, and in some embodiments, the troughs are other than full, half, or quarter sizes such as described above for example. Consequently, in some embodiments, the modular reservoir assemblies can consume less storage space than prior art unitary reservoirs while providing the ability to adapt one or more troughs to differing storage and use environments.

Some embodiments are compatible for use in both manual and robotic systems.

In some embodiments, any quantity or orientation of trough modules fitting can fit within the frame and, if desired, be compatible with robotic systems. Reservoir troughs can also be, in some applications, self-standing for manual use, and may be used with or without the frame in any desired configuration, connected together or not, in any desired orientation.

Some applications provide a reservoir frame providing relatively lower or much lower frame height than the height of a trough mounted in the reservoir frame. In some embodiments, this can provide a low profile reservoir frame with much less material than required for larger frames, which can also reduce frame manufacturing and shipping costs and storage space as well.

In some embodiments, the reservoir frame can provide a frame width that can aid in stabilizing a reservoir having one or more troughs or, in some instances, other components mounted to the reservoir frame.

In some embodiments, one or more troughs, and in some embodiments, other components, include mounting clips, projections, or tabs extending from a first set of two adjacent sides, and these clips, projections, or tabs are adapted to matingly engage mating portions of, such as channels in, the reservoir frame or, in some embodiments, other troughs or other components mountable within the reservoir frame. In some embodiments the troughs, in some embodiments, other components, include such matingly engaging mating portions, such as channels for example. In some instance, other types of interconnecting features may be utilized to interconnect one or more troughs, or other structures, to themselves or a reservoir frame as desired.

Conversely, the frame may include mounting clips, projections, or tabs adapted to matingly engage mating portions, such as channels for example in, the reservoir frame.

In some embodiments, the reservoir frame is adapted to accommodate many differing sizes and configurations of troughs or other components mountable to the frame. For example, the troughs or other components may be rectangular and in whole, half, or quarter sizes as compared to the size of an interior mounting passage within the frame, but the troughs or other components may be any of a wide variety of other sizes and not, in some embodiments, not extend the full length of either the interior mounting passage width or length of the reservoir frame.

Some applications provide completely or partially opaque components. In some instances, this can allow the user to dispense with wrapping the reservoir or any of its components with light blocking material.

Some applications provide reusable components. Some applications provide recyclable components. Some applications provide one or more SBS compliant components.

Some troughs provide a number of interior chambers, such as in, for example, the bottom of the troughs. The chambers may all provide an inverted pyramid shape.

Some such inverted pyramid shapes may abut an upwardly extending side of the trough in a fashion cutting into pyramid shape, narrowing its width and reducing its volume. The angle of an inverted pyramid side abutting such a trough side can be adjusted so that the trough-side abutting chamber provides the same volume or substantially the same volume as other chambers in the trough, such as one or more of those that do not abut a trough side.

This disclosure also provides novel methods of assembly of a reservoir. One such method includes securing two sides of a trough to two mating interior sides of a reservoir frame. The method can also include, if desired, securing at least one side of one trough to a mating side of a second trough. The method can further include, if desired, securing at least an abutting second side of the second trough to another mating interior side of a reservoir frame.

There are many other novel features and aspects of this disclosure. The will become apparent as this specification proceeds. It is to be understood, however, that the scope of the invention is to be determined by a claim as issued and not by whether the claim addresses an issue, or provides a feature, because the issue or feature was referenced in the Background or Brief Summary sections above.

### BRIEF DESCRIPTION OF THE DRAWINGS

The inventors' preferred and other embodiments are described in association with the accompanying Figures in which:

FIG. 1 is perspective view of an SBS-compatible reservoir having four modular SBS-compatible troughs, with three differing trough configurations, mounted within a low profile rectangular frame;

FIG. 2 is an exploded perspective view of the SBS-compatible reservoir of FIG. 1;

FIG. 3 is a perspective view of one of the four modular SBS-compatible troughs of FIG. 1;

FIG. 4 is a plan view of the trough of FIG. 3;

FIG. 5 is a cross-sectional view taken along section line 5-5 of FIG. 4, showing a series of clip mounting channels penetrating the lower edge of the trough;

FIG. 6 is an enlarged partial cross-sectional view of a lower edge and corner portion of the cross-sectional view of FIG. 5;

FIG. 7 is a partial plan view of a segment of the trough of FIG. 3, showing a mounting clip extending outwardly from the trough;

FIG. 8 is a cross-sectional view taken along section line 8-8 of FIG. 7;

FIG. 9 is a partial cross-sectional view showing a trough mounting clip mounted within a clip mounting channel;

FIG. 10 is a partial perspective view of the trough of FIG. 3 aligned to be mounted to an associated reservoir frame portion;

FIG. 11 shows trough section of FIG. 10 mounted to the associated reservoir frame portion of FIG. 10;

FIG. 12 is a perspective of the reservoir frame of FIG. 2;

FIG. 13 is a cross-sectional view taken along section line 13-13 of FIG. 12;

FIG. 14 is a partial cross-sectional view of the left side segment of reservoir frame of FIG. 13;

FIG. 15 is a partial cross-sectional view of the left side segment of FIG. 14 with the trough of FIG. 3 removably mounted to the reservoir frame and having a mounting clip of the trough mounted with a mating clip mounting channel in the reservoir frame; and

FIG. 16 shows an alternative arrangement of five troughs, consisting of two differing types of troughs, mounted within a reservoir frame of the same type shown in FIG. 12.

### DETAILED DESCRIPTION OF SOME EMBODIMENTS

The prior Brief Summary and the following description provide examples, and are not limiting of the scope of this specification. One skilled in the art would recognize that changes can be made in the function and arrangement of elements discussed without departing from the spirit and scope of the disclosure. Various embodiments can omit, substitute, add, or mix and match various procedures or components as desired. For instance, the methods disclosed can be performed in an order different from that described, and various steps can be added, omitted, or combined. Also, features disclosed with respect to certain embodiments can be combined in or with other embodiments as well as features of other embodiments

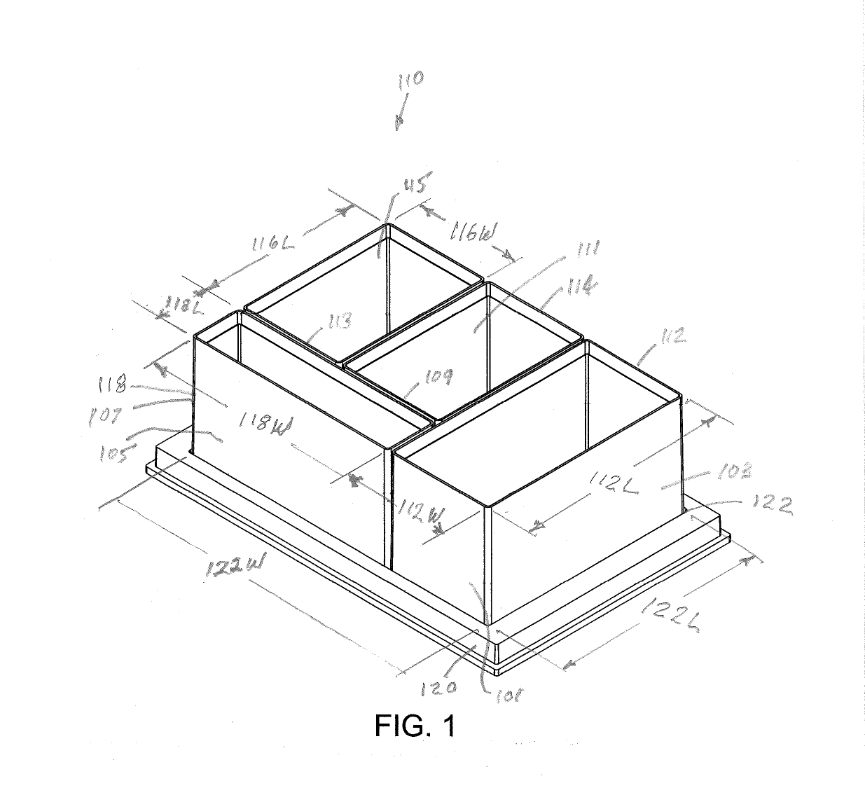

Referring now to FIG. 1, an SBS-compatible reagent reservoir, generally 110, has four reusable SBS-compatible rectangular reagent troughs 112, 114, 116, 118, removably mounted within a reusable lower, SBS-compatible rectangular reservoir frame 120. Two of the troughs 114, 116 have the same configuration (and provide the same volume within them 114, 116); and the two other troughs 112, 118 have differing configurations (and provide differing volumes with them 112, 118).

The SBS-compatible frame 120 has a length 122L of 72.20 mm, which is substantially less than the its width 122W of 108.20 mm. Trough 112 has a length 112L of 72.0 mm, which is approximately twice its width 112 W of 36.0 mm. Troughs 114 and 116 have a the same width, e.g., 116W, and the same length, e.g., 116L. Trough 118 has a width 118W much larger that its length, 118L. In this example embodiment 110, it can be seen that the length of a trough, e.g., 118 and 116, need not extend with the entire mounting channel length 122L or width 122W. Further, any up to three of the four troughs 112, 114, 116, 118, can be mounted so that when removed (or if not mounted in the frame 120 during the reservoir assembly process), the other(s) of the troughs mounted in the frame 120 remain held in position within the frame 120 notwithstanding the absence of troughs within a substantial portion of the frame mounting channel 122. Of course, these dimensions and the size and orientation of the reservoir frame and troughs of FIG. 1 may be altered as desired for a given application.

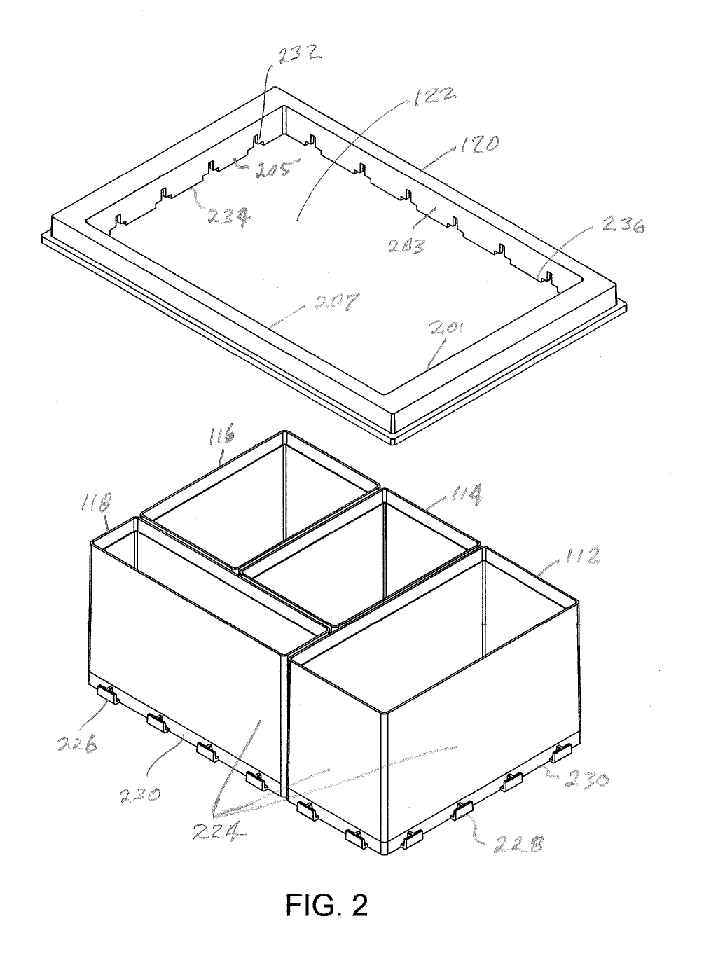

Referring to FIG. 2, the four troughs 112, 114, 116, 118 can be selected by the user and then manually mounted to each other. Then, the interconnected troughs 112, 114, 116, 118 can be mounted within reservoir frame 120. This can be accomplished by manually (or otherwise) sliding the frame 120 over the collective outer periphery 224 of the interconnected troughs 112, 114, 116, 118 so that trough mounting clips, e.g., 226, 228, extending outwardly from the lower edge 230 of the interconnected troughs 112, 114, 116, 118 penetrate mating trough clip mounting channels (not shown in FIG. 2 but see other similarly shaped trough clip mounting channels 232, 234) in, and extending upwardly from, the bottom interior edge 236 of the frame 120.

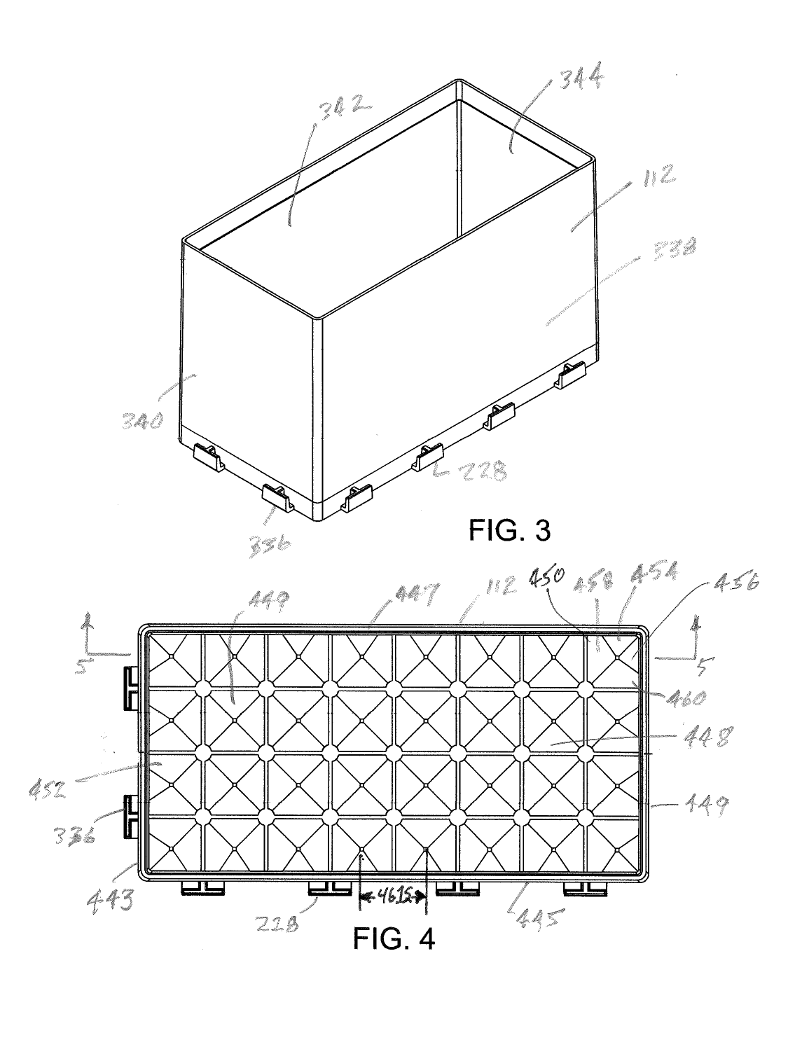

Turning to FIG. 3, each of the troughs of FIG. 1, e.g., 112, have four generally rectangular and planar sides, e.g., 338, 340, 342, 344, and also have trough mounting clips, e.g., 228, 336, extending outwardly from only two adjacent sides 338, 340 of the trough, e.g., 112. As will be seen as this specification proceeds, this allows secure mounting of a given trough to a frame (not shown in FIG. 3) and/or another abutting trough (not shown in FIG. 3).

With reference now to FIGS. 4, 5, and 6, the bottom portion 446 of the trough 112 contains a number of inverted-pyramid-shaped chambers, e.g., 448, 449. The chambers, e.g., 450, 452, abutting the sides 338, 340, 342, 344 have somewhat distorted inverted-pyramid-shapes. The distorted inverted-pyramid sides, e.g., 454, 456, are at a lower angle to the plane of the bottom 446 of the trough 112 than are the non-distorted sides, e.g., 458, 460, so that volume of the inverted-pyramid-shaped chambers, e.g., 450, is the same as the volume of the distorted inverted-pyramid-shaped chambers, e.g., 448. The spacing from pyramid peak to adjacent pyramid peak 461S is 9 mm, rendering the FIG. 1 troughs, e.g., 112, compatible with both multichannel pipette heads and individual pipette heads.

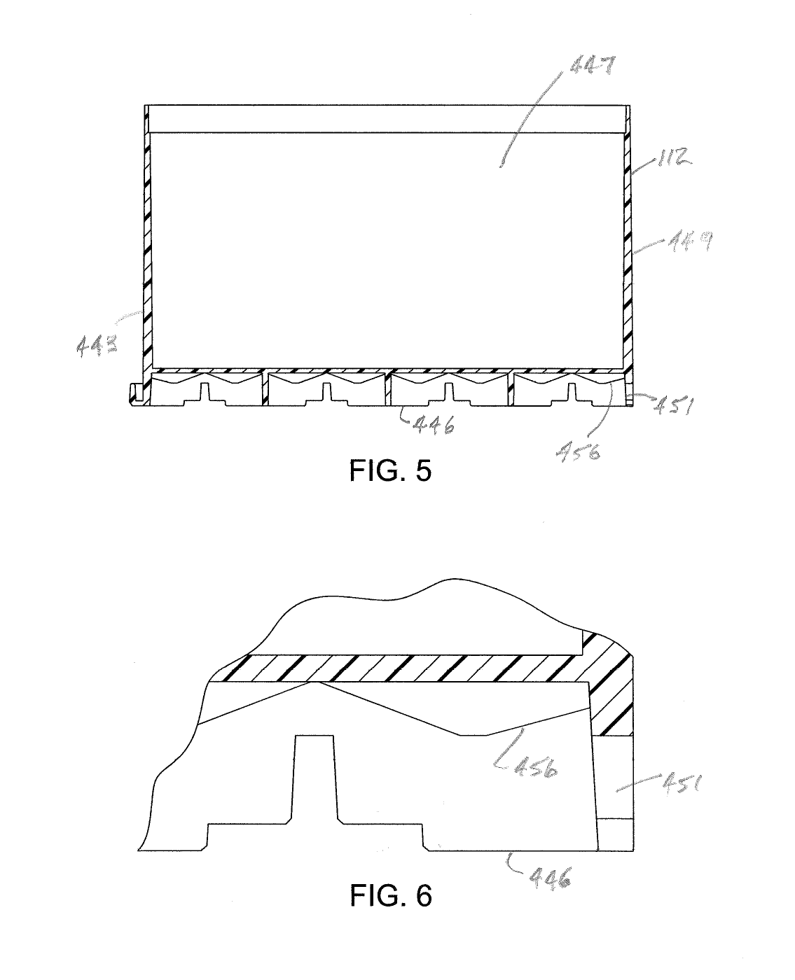

Referring to FIGS. 4 and 5, two adjacent sides 443, 445 have mounting clips, e.g. 228, 336, extending outwardly from them. The remaining two adjacent sides 447, 449 have mounting clip channels, e.g., 446, 451, penetrating them 447, 449.

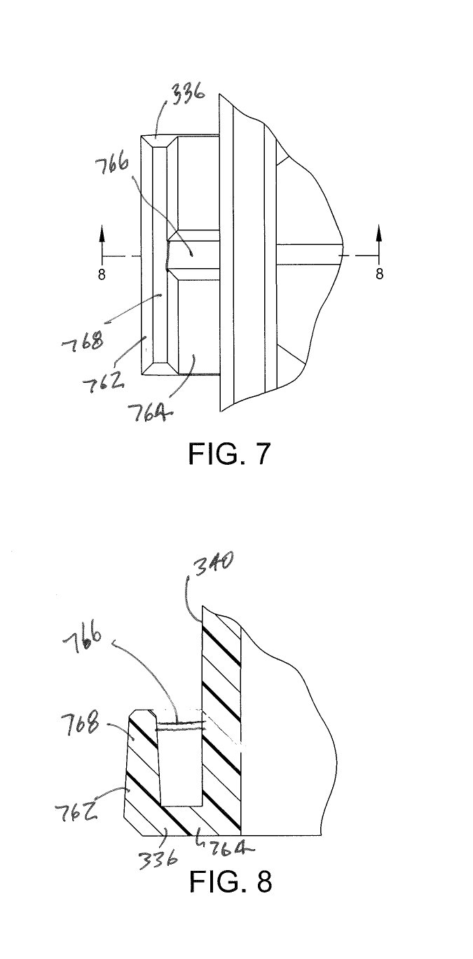

With reference to FIGS. 7 and 8, each trough mounting clip, e.g., 336, has a T-shaped section 762 extending (i) transversely outwardly from the lower edge of the associated rectangular side from which the mounting clip, e.g., 336, extends, and (ii) upwardly from a lower base section 764 in the clip 336. The lower base section 764 also extends transversely outwardly from the lower edge of the same rectangular side as well transversely to the T-shaped section 762 of the mounting clip, e.g., 336. The T-shaped section 762 has (i) a central beam 766 section; and (ii) a transverse beam section 768 transverse to, and extending from, the central beam 766 section.

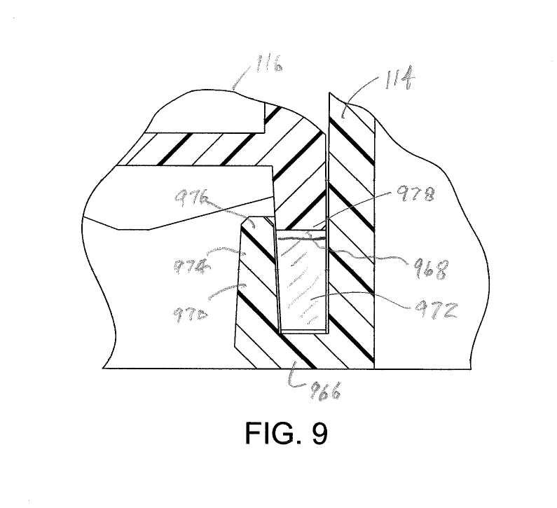

With reference now to FIG. 9 depicting how one trough, e.g., 114, can be secured to another, e.g., 116, via a trough mounting clips, e.g., 966, extending from the one trough, e.g., 114, to fully penetrate an adjacent and mating trough mounting channel, e.g., 968, in an adjacent trough, e.g., 116. In this position, the upwardly extending T-shaped section 970 of the mounting clip 966 has: (i) a central beam 972 of T-shaped section 970 extending through a mating beam channel 972 in the trough mounting channel 968; and (ii) a transverse beam 974 having an upper beam end 976 abutting the upper end 978 of the segment of the trough, e.g., 114, forming the trough mounting channel 968.

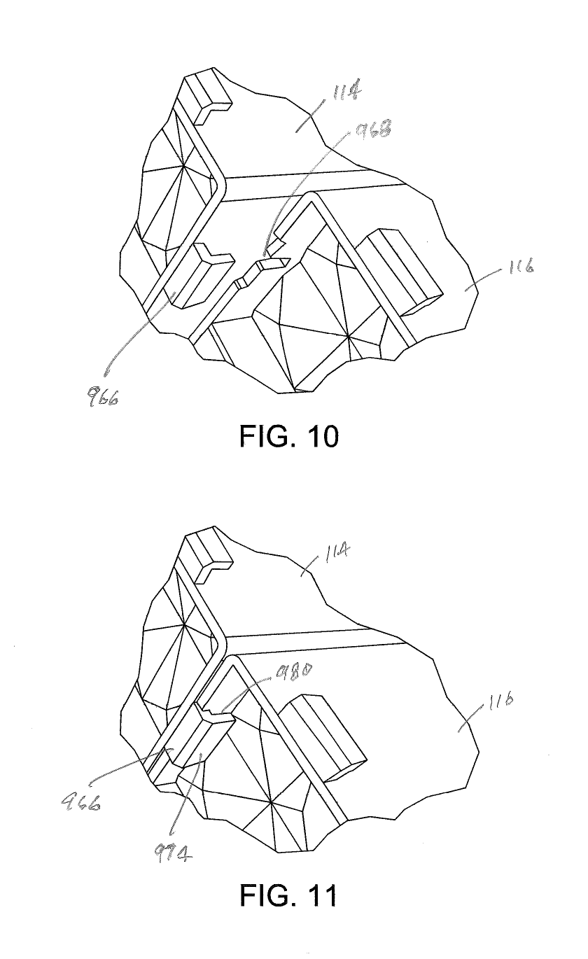

With reference to FIGS. 10, the secured position of FIG. 9 can be accomplished by positioning one trough, e.g., 116 adjacent the other trough, e.g., 114, so that the trough mounting channel 968 is located laterally spaced from the mounting clip 966. The user then moves the trough, e.g., 116, so that, with reference now to FIG. 11, the mounting clip 966 is friction into position within the trough mounting channel 968. In this position, the transverse beam 974 of the mounting clip 966 firmly abuts the interior side wall segment 980 surrounding the trough mounting channel 968.

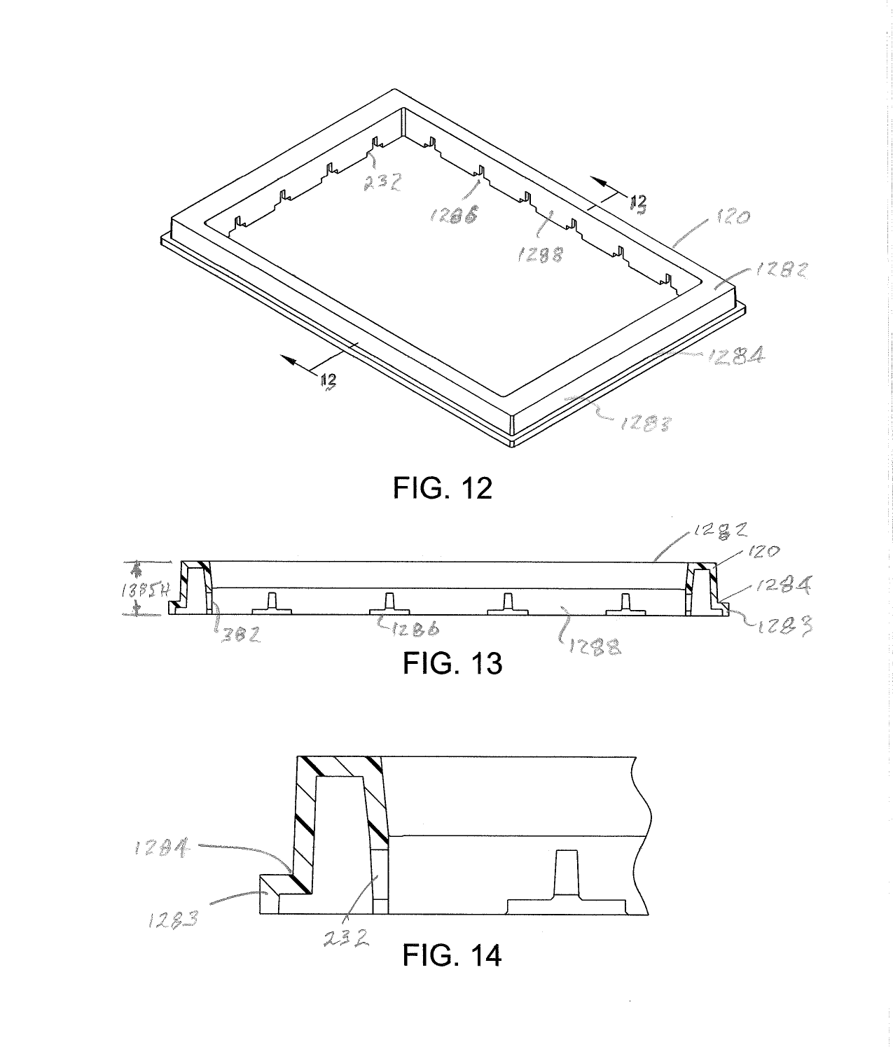

Turning now to FIGS. 12 and 13, the reservoir frame 120 has a thickened central rectangular frame 1282 with a lower stabilizing rectangular lip section 1283 extending transversely outwardly from the lowermost outer periphery 1284 of the central rectangular frame 1282. Mounting clip channels, e.g., 232, 1286, 1384, penetrate the interior side wall 1288 of the central rectangular frame 1282.

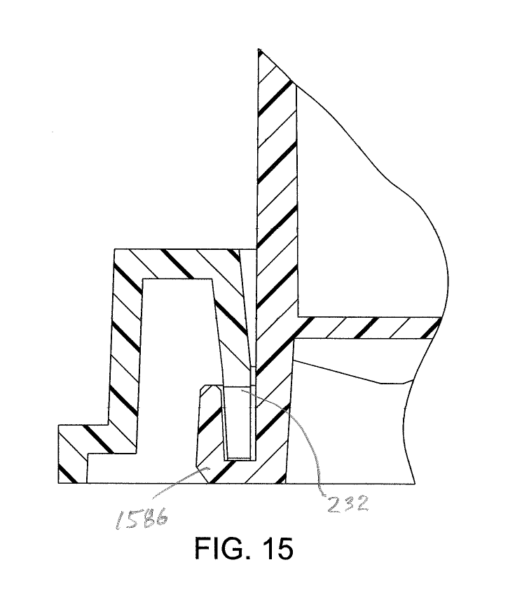

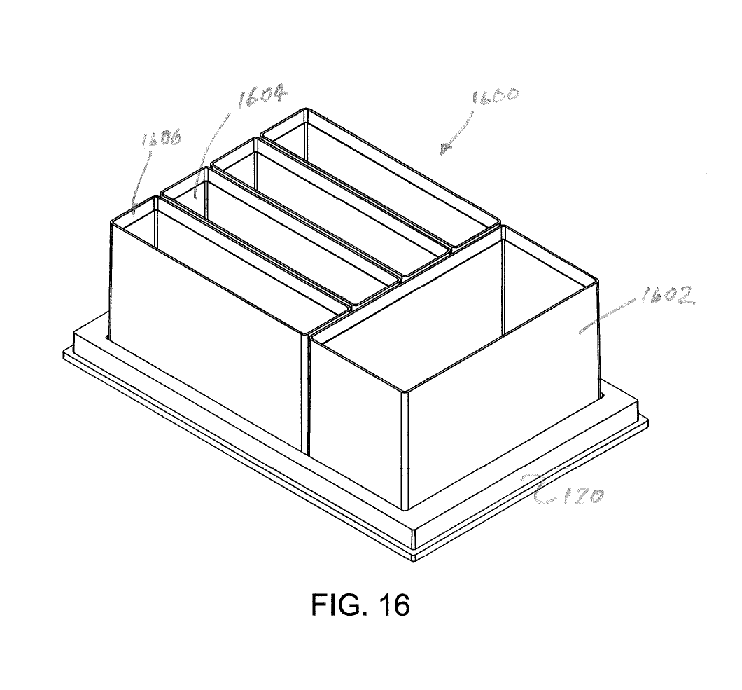

With reference to FIG. 15, a trough mounting clip 1586 can be mounted to penetrate a clip mounting channel 232 in the same fashion as described with respect to trough-to-trough mounting described in connection with FIGS. 9-11 above. With reference to FIGS. 1 and 2, clip mounting channels on a given reservoir frame are thus located at uniformly spaced distances from each other (i.e., on each of the four planar interior sides 201, 203, 205, 207), as are the mating mounting clips on each of sides the troughs bearing mounting clips.

With reference to FIG. 1, mounting clips can be included, for example on trough side pairs: 101 & 103; 105 & 107; 109 & 111; and 113 & 115. The resulting reservoir assembly 110 is secure and can be easily moved without relative motion between the components. This is due to (i) interconnection of the mounting clips with their respective clip mounting channels in either an abutting trough or interior side of the reserve frame 120; and (ii) otherwise abutting sides of adjacent troughs and trough sides abutting the interior side of the reserve frame. The trough side pairs can be oriented in differing locations within the reservoir assembly and achieve the same end.

With reference now to FIG. 16, the possible alternatives for trough orientations and shapes mountable in the reservoir frame 120 are virtually unlimited. One alternative orientation, generally 1600, utilizes two differing types of troughs 1602, 1604. Rather than being limited to whole, half, or quarter sized troughs (i.e., as compared to the entire trough volume supportable within the reservoir frame 120), the troughs can be of any other practical size, such as ⅓, ⅛, ⅙, etc.

One method of assembly of a reservoir assembly can constitute:
procuring a rectangular reservoir frame having clip mounting channels penetrating the interior somewhat-rectangular and planar sides of the frame;
selecting one or more troughs or other components having a rectangular outer periphery with (i) two adjacent outer sides each having at least one mounting clip extending outwardly from the side and (ii) the two other adjacent sides each having at least clip mounting channel penetrating the side;
mounting the troughs or other components by sliding one or more mounting clips to penetrate or more mating clip mounting channels in either the reservoir frame or a mating side of a trough or other component.

In some applications, the reservoir frame 120 need not be completely filled. In such an event, only the needed trough(s) need be mounted within the reservoir frame 120. For example, the reservoir assembly might only have one trough, e.g., 1602 or 1606. Or, the assembly may have only two troughs, e.g., 1604, 1606.

Other types of components, not merely one or more troughs, can be mounted with the reservoir frame 120. Such components can be made easily mountable with the reservoir frame 120 by providing one or more sufficient mounting clips at appropriate locations to mate with clip mounting channels within the reservoir frame 120.

The troughs can be structured differently than as shown in the accompanying Figures. For example, they may have interior chambers formed by one or more walls spanning from one wall to an opposing wall in a trough. Similarly, pyramidal chambers can be made smaller or larger, in depth or width or both.

In addition, the interconnecting structure can be revised to that the reservoir frame has mounting tabs, clips, or projections rather than, or in addition to, mounting channels. In a reservoir frame having mounting tabs substituted for the mounting channels such as described in association with the Figures above, the frame's mounting tabs, clips, or projections can penetrate mating mounting channels on troughs or other components, while mounting tabs, clips, or projections on the troughs or other components can interconnect with mating channels the troughs or other components.

One or more of the troughs or other components may be made of opaque material, such as black plastic for example. One alternative is to have all reagent containing troughs as well as the reservoir frame made of black plastic, and of course other reservoir components can be made of materials having other colors or light transmission or filtering characteristerics.

The reservoir frame can have a wide variety of configurations differing from that shown in the accompanying Figures. It can provide a wider or narrower reservoir assembly base if desired. Similarly, it can be thicker (height from top to bottom). The height 1385H of the frame 120 shown in FIG. 12 is 8.0 mm. The frame can be as high as desired, but generally the height of the frame embodiment is 2 to 3 centimeters or less (i.e., or any lesser height within that range). In another aspect the frame may be any size substantially less than the height of a trough, or, if desired, other component, to be mounted within the frame, although in other embodiments the frame may be of any desired height as can one or more troughs or other components to be mounted to the frame. The structure for interconnecting troughs and troughs to the frame can be any of many other designs as well. For example, the clips can have differing shapes, and similarly the mounting channels can have other mating shapes. In another example, other types of fasteners, such as pins, may be utilized.

While some or all components can be SBS-compatible, the components need not be compliant with the SBS standard. One or more such components could comply with other or no standards as desired while utilizing features and methods disclosed in this specification.

It can thus be seen that some advantages of the depicted embodiments include the following:

They can be made of relatively minimal material to provide the reservoir assembly. The material can be very lightweight, such as polyethylene, polypropylene, or other lightweight plastic. An embodiment such as the assembly of FIG. 1 made of polypropylene weighs 48.01 grams, and the polypropylene embodiment of FIG. 16 weighs 52.978 grams. Of course, the weight of the these embodiments can be altered by varying volume, density, or other aspects of of reservoir assembly material utilized in a given embodiment.

A facility can provide a great variety of differing types reservoir assemblies with relatively few components and, if desired, relatively little storage as compared to prior art reservoirs and reservoir assemblies. In addition, costs for procurement can be significantly reduced by the present assemblies as compared to prior art assemblies.

When multiple troughs are assembled together, the entire assembly can be stored, moved, and handles as a single unit. Interconnectivity provides today stability. Individual smaller reservoirs can easily fall over and spill their contents. Multiple interconnected troughs can be stored in optimum environmental conditions and the user can then remove just the needed troughs. The remaining interconnected troughs remain stabilized by one another.

The reservoirs can be combined into many configurations, allowing the user to create a configuration that is most efficient for the user's purpose. This flexibility of user design and geometry of reservoirs allows users to design their liquid transfer methods in their preferred orientation, solving the problem of being limited by their labware on how they can design their experiments.

When prefilled, each individual reservoir can be stored in different environmental conditions until needed individually or as a unit assembly. This allows the user to store smaller units of material in optimum environmental conditions, saving expensive environmentally controlled storage space.

In the embodiments of the accompanying figures, users can put any number of troughs into the SBS frame while still providing positive placement due to precise location of the troughs within the frame, even when the frame is not completely filled with troughs or other components.

On reading this specification, those of skill in the art will recognize that many of the components discussed as separate units may be combined into one unit and an individual unit may be split into several different units. Further, the various functions could be contained in one computer or spread over several networked computers and/or devices. The identified components may be upgraded and replaced as associated technology improves, advances are made in computing technology, or based on a developers skills or preferences.

The process parameters, functions, system features, and sequence of steps described and/or illustrated herein are given by way of example only and may be varied and mixed and matched as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The foregoing detailed description has described some specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems, their components, and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.” Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

What we claim is:

1. A reservoir assembly comprising in combination:
A. at least one trough having a rectangular outer periphery and at least one mounting tab extending from the rectangular outer periphery;
B. a reservoir frame having a rectangular interior trough mounting passage and at least one mounting tab channel penetrating the rectangular interior trough mounting passage.

2. A reservoir assembly of claim 1 comprising in combination:
A. a plurality of troughs each having a rectangular outer periphery and at least one mounting tab extending from the rectangular outer periphery;
B. an SBS compatible reservoir frame having a rectangular interior trough mounting passage and a plurality of mounting tab channels penetrating the rectangular interior trough mounting passage.

3. The reservoir assembly of claim 2 wherein at least two among the plurality of troughs have substantially differing configurations.

4. The reservoir assembly of claim 1 wherein the one trough also has a mounting tab channel penetrating the rectangular outer periphery.

5. The reservoir assembly of claim 2 wherein the plurality of troughs each also have a mounting tab channel penetrating the rectangular outer periphery.

6. The reservoir assembly of claim 3 wherein the plurality of troughs each also have a mounting tab channel penetrating the rectangular outer periphery.

7. The reservoir assembly of claim 1 wherein the reservoir frame has height less than 2 centimeters high.

8. The reservoir assembly of claim 6 wherein the reservoir frame has height less than 2 centimeters high.

9. The reservoir assembly of claim 1 wherein the one trough consists essentially of opaque material.

10. The reservoir assembly of claim 8 wherein at least one among the plurality of troughs consists essentially of opaque material.

11. A method of assembling an reservoir assembly comprising:
procuring an SBS-compatible reservoir frame;
selecting a plurality of;
interconnecting the plurality of troughs;
mounting the interconnected troughs to the SBS-compatible frame.

12. The reservoir assembly method of claim 11, wherein the plurality of includes a first trough having first configuration and a second trough having a second configuration substantially differing from the first configuration.

13. The reservoir assembly method of claim 11, further comprising:
in the interconnecting step, mounting at least one mounting clip, extending from at least one among the plurality of troughs, into a clip mounting channel in another among the plurality of troughs.

14. The reservoir assembly method of claim 12, further comprising:
in the interconnecting step, mounting at least one mounting clip, extending from the first trough into, a clip mounting channel in the second trough or another trough.

15. The reservoir assembly method of claim 11, further comprising:
in the mounting step, mounting at least one mounting clip, extending from at least one among the plurality of troughs, into a clip mounting channel in the frame.

16. The reservoir assembly method of claim 11, further comprising:
in the mounting step, mounting at least one mounting clip, extending from at least one among the plurality of troughs, into a clip mounting channel in the frame.

17. The method of assembling of claim 12, further comprising:
in the mounting step, mounting at least one mounting clip, extending from at least one among the plurality of troughs, into a clip mounting channel in the frame.

18. The reservoir assembly method of claim 13, further comprising:
in the mounting step, mounting at least one mounting clip, extending from at least one among the plurality of troughs, into a clip mounting channel in the frame. rectangular trough dominantly comprise opaque material.

19. A reservoir assembly comprising in combination:
A. an SBS-compatible trough frame mount providing a rectangular interior trough mounting passage, the rectangular interior trough mounting passage having a first plurality of trough clip mounting channels; and
B. a plurality of rectangular troughs modules, each having (i) a plurality of trough mounting clips extending outwardly from a first lower trough edge of a first set of two abutting trough sides and (ii) a second plurality of trough clip mounting channels penetrating a second lower trough edge of a second set of two abutting trough sides.

20. The reservoir assembly of claim 19 wherein the SBS-compatible trough frame has a frame height less than 2 centimeters.

21. The reservoir assembly of claim 19 wherein at least one among the plurality of rectangular trough modules consists dominantly of opaque material.

22. The reservoir assembly of claim 20 wherein at least one among the plurality of rectangular trough modules consists dominantly of opaque material.
